(19) United States
(12) Patent Application Publication
(10) Pub. No.: US 2022/0242357 A1
(43) Pub. Date: Aug. 4, 2022

(54) FRONT AIRBAG FOR MOUNTING ON A VEHICLE ROOF AS WELL AS FRONT AIRBAG MODULE AND VEHICLE COMPRISING SUCH FRONT AIRBAG

(71) Applicant: Dalphi Metal Espana S.A., Vigo (ES)

(72) Inventor: Óscar Ugarte Alba, Valladolid (ES)

(21) Appl. No.: 17/639,828

(22) PCT Filed: Aug. 31, 2020
(86) PCT No.: PCT/EP2020/074210

§ 371 Date: Mar. 2, 2022

(30) Foreign Application Priority Data
Sep. 2, 2019 (DE) 10 2019 123 452.2

(51) Int. Cl. B60R 21/213; B60R 21/231

(52) U.S. Cl. CPC B60R 21/213; B60R 2021/0048; B60R 21/231

(57) ABSTRACT

The disclosure relates to a front airbag for mounting on a vehicle roof, comprising an airbag mouth for filling an inflatable airbag volume with generator gas which in a mounted condition of the front airbag faces the vehicle roof, and comprising an airbag panel which defines a shape of the inflatable airbag volume and, in the mounted and inflated condition of the front airbag, includes a frontal impact surface for a vehicle occupant to be protected, wherein at a lateral edge of the frontal impact surface a support element protruding from the frontal impact surface toward the vehicle roof is provided for contacting and laterally stabilizing an occupant's head. Moreover, the disclosure also relates to a front airbag module and a vehicle comprising such front airbag.

### CROSS-REFERENCE TO RELATED APPLICATIONS

This application is a national stage of International Application No. PCT/EP2020/074210, filed Aug. 31, 2020, the disclosure of which is incorporated herein by reference in its entirety, and which claimed priority to German Patent Application No. 102019123452.2, filed Sep. 2, 2019, the disclosure of which is incorporated herein by reference in its entirety.

### TECHNICAL FIELD

The disclosure relates to a front airbag for mounting on a vehicle roof, comprising an airbag mouth for filling an inflatable airbag volume with generator gas, the airbag mouth facing the vehicle roof in the mounted condition of the front airbag, comprising an airbag panel defining the shape of the inflatable airbag volume and, in the mounted and inflated condition of the front airbag, having a frontal impact surface for a vehicle occupant to be protected.

### BACKGROUND

Roof-mounted airbags are already generally known from prior art and are in use, for example, as front airbags in the passenger area, where they deploy from a cross member of the vehicle roof over the windshield and the instrument panel of the vehicle. In the event of a frontal crash, a portion of the roof-mounted airbag forms a frontal impact surface for the vehicle occupant and rests against the instrument panel to protect especially the head and the thorax of the vehicle occupant.

It is an advantage to accommodate airbag modules at or within the vehicle roof, as especially high flexibility for the interior concept of the vehicle is resulting therefrom.

However, it has turned out that there is still room for improvement of restraining comfort of such airbag in the event of diagonal crash of the vehicle.

### SUMMARY

What is needed is a roof-mountable front airbag which provides improved occupant restraint especially in the event of diagonal crash of the vehicle.

In accordance with the disclosure, a front airbag of the above-mentioned type is disclosed in which at a lateral edge of a frontal impact surface a support element protruding from the frontal impact surface toward the vehicle roof is provided for contacting and laterally stabilizing an occupant's head. The “lateral” edge in this context relates to a longitudinal vehicle axis and here concretely means that a support element extends on a left and/or right side of the vehicle occupant when the latter contacts the frontal impact surface.

A support element of this type can contact and stabilize the vehicle occupant's head especially in the event of a diagonal crash of the vehicle. Thus, the support element helps to reliably reduce or even prevent rotation of the occupant's head about a longitudinal axis of the body or lateral sliding of the occupant's head off the frontal impact surface of the airbag due to a lateral acceleration component. In this way, a physical strain during occupant restraint can be reduced and the restraining comfort can be improved for the vehicle occupant.

In one exemplary arrangement, the lateral support element is a flexible flat support element, such as, for example, a fabric flap or a foil and, in an inflated condition of the front airbag, spans a plane extending substantially normal to a transverse vehicle direction. In one exemplary arrangement of the front airbag, the support element is a single-layer fabric sail which, upon airbag deployment, is spanned at the lateral edge of the frontal impact surface. Such support element requires hardly any space and entails merely little extra expenditure during airbag manufacture.

In another exemplary arrangement of the front airbag, the lateral support element is double-layered and is in flow communication with the inflatable airbag volume. The support element accordingly forms an inflatable sidewall portion of the front airbag projecting from the frontal impact surface. As compared to a non-inflatable design, such inflatable support element may be somewhat softer when it contacts an occupant, but it is more expensive with respect to the airbag manufacture.

In one exemplary arrangement, the support element is tightly connected to an airbag panel. The support element is designed, for example, as a separate airbag component and is sewn to the airbag panel. In one exemplary arrangement, with inflatable support elements, it is alternatively imaginable for the support element to be integrated in the airbag cut and thus to be formed integrally with the airbag panel.

In one exemplary arrangement, at each of the two opposite lateral edges of the frontal impact surface a support element protruding from the frontal impact surface toward the vehicle roof is provided for contacting and laterally stabilizing the occupant's head. Such front airbag then exhibits improved occupant restraint irrespective of the direction of the diagonal crash.

According to another exemplary arrangement, the front airbag comprises an inflatable first airbag leg for resting against a first vehicle component, for example, a windshield, which airbag leg extends, in the mounted and inflated condition of the front airbag, from an airbag mouth toward a second vehicle component, especially an instrument panel, and an inflatable second airbag leg for resting against the second vehicle component, which airbag leg extends from an end of the first airbag leg opposed to the airbag mouth to a free leg end and includes the frontal impact surface for the vehicle occupant to be protected, wherein the first airbag leg encloses an angle α with α<180° with the second airbag leg and defines a clearance facing the vehicle occupant to be protected, and wherein said clearance is confined by the support element at a lateral airbag edge.

In one exemplary arrangement, the support element is tightly connected, especially sewn, both to the first airbag leg and to the second airbag leg. Due to the airbag cut as well as the geometric constraints in the vehicle interior, upon deployment of the front airbag the wedge-shaped clearance facing the vehicle occupant is automatically formed between the airbag legs. By the fixation on the first and second airbag legs, also the support element is automatically spanned in a simple manner as a lateral limitation of the wedge-shaped clearance.

In this exemplary arrangement, too, the clearance defined by the two airbag legs and facing the vehicle occupant to be protected may be confined by a respective support element at each of the two opposed lateral airbag edges. As already mentioned above, such front airbag then exhibits improved occupant restraint irrespective of the direction of the diagonal crash.

The disclosure further comprises a front airbag module for mounting on a vehicle roof, comprising an afore-described front airbag and a gas generator mountable to the vehicle roof for filling the front airbag with generator gas through the airbag mouth thereof.

Finally, the disclosure also relates to a vehicle comprising a windshield extending in a transverse vehicle direction, a vehicle roof having a roof cross member adjacent to an upper edge of the windshield, an instrument panel extending adjacent to a lower edge of the windshield away from the windshield in the direction of a vehicle interior, and a front airbag module mounted on the roof cross member which includes an afore-described front airbag, wherein the support element has a flat design and spans a plane extending substantially normal to the transverse vehicle direction.

### BRIEF DESCRIPTION OF DRAWINGS

Further features and advantages of the disclosure will be evident from the following description of an exemplary arrangement with reference to the drawings, wherein:

FIG. 1 shows a schematic perspective view of an inflated front airbag mounted in the vehicle roof as known from prior art;

FIG. 2 shows a schematic perspective view of a front airbag according to the disclosure mounted in the vehicle roof in its inflated condition; and

FIG. 3 shows another schematic perspective view of a front airbag according to the disclosure mounted in the vehicle roof in the case of impact of an occupant.

### DETAILED DESCRIPTION

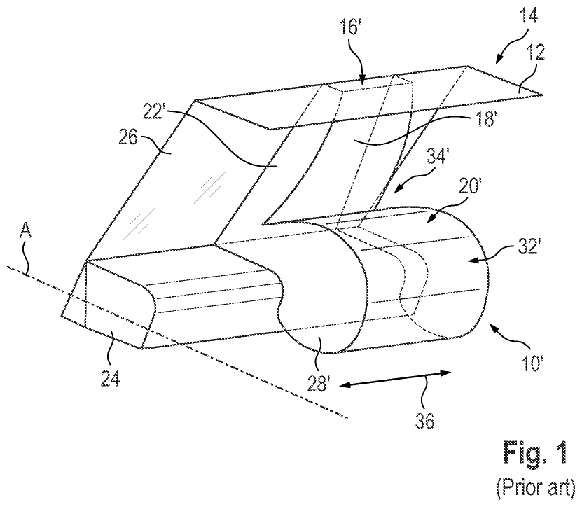

FIG. 1 illustrates a conventional front airbag 10′ mounted beneath a vehicle roof 12 of a vehicle 14. The front airbag 10′ comprises an airbag mouth 16′ facing the vehicle roof 12 and being adapted to fill an inflatable airbag volume with generator gas, as well as an airbag panel 18′ which defines a shape of the inflatable airbag volume and, in an inflated condition of the front airbag 10′, includes a frontal impact surface 20′ for a vehicle occupant to be protected.

More specifically, the front airbag 10′ comprises a first airbag leg 22′ extending from the airbag mouth 16′ toward an instrument panel 24 and resting against a windshield 26 of the vehicle 14 as well as a second airbag leg 28′ extending from an end of the first airbag leg 22′ opposed to the airbag mouth 16′ to a free leg end 32′ and resting against the instrument panel 24. The second airbag leg 28′ has the frontal impact surface 20′ for the vehicle occupant to be protected and, according to FIG. 1, with the first airbag leg 22′ encloses a wedge-shaped clearance 34′ that faces the vehicle occupant to be protected. With respect to a longitudinal vehicle axis A, the wedge-shaped clearance 34′ is open to the side, i.e. at the airbag edges opposed in the transverse vehicle direction 36.

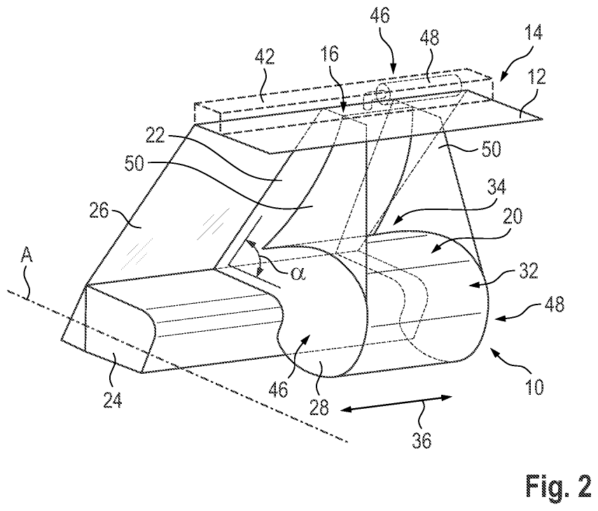

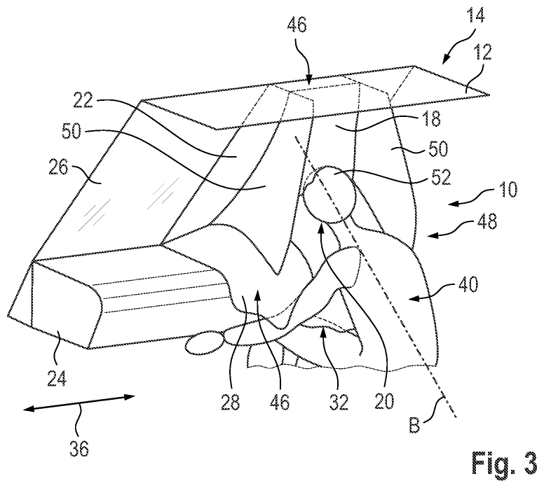

In FIG. 2, a cutout of a vehicle 14 is schematically illustrated, comprising a windshield 26 extending in the transverse vehicle direction 36, a vehicle roof 12 having a roof cross member 46 adjacent to an upper edge of the windshield 26, and an instrument panel 24 extending, adjacent to a lower edge of the windshield 26, away from the windshield 26 toward the vehicle interior, especially toward a vehicle occupant 40 to be protected (see also FIG. 3).

The vehicle 24 further comprises a front airbag module 42 mounted on the vehicle roof 12 comprising a front airbag 10 and a gas generator 48 mounted on the vehicle roof 12, concretely on the roof cross member 46 of the vehicle roof 12, which gas generator, when being activated, fills the front airbag 10 with generator gas.

Analogously to FIG. 1, the front airbag 10 mounted beneath the vehicle roof 12 comprises an airbag mouth 16 facing the vehicle roof 12 which is connected to the gas generator 48 for filling an inflatable airbag volume with generator gas, and an airbag panel 18 which defines the shape of the inflatable airbag volume and, in the mounted and inflated condition of the front airbag 10, has a frontal impact surface 20 for the vehicle occupant 40 to be protected.

In contrast to the conventional front airbag 10′ according to FIG. 1, in the front airbag 10 according to FIG. 2, however, at a lateral edge 46, 48 of the frontal impact surface 20, a support element 50 protruding from the frontal impact surface 20 toward the vehicle roof 12 is provided for contacting and laterally stabilizing a head 52 of the vehicle occupant 44 to be protected.

In the shown exemplary arrangement, especially at each of the two opposite lateral edges 46, 48 of the frontal impact surface 20 such support element 50 is provided, with the lateral edges 46, 48 in this case substantially corresponding to airbag edges of the front airbag 10 opposed in the transverse vehicle direction 36.

According to FIG. 2, each of the two separate support elements 50 is in the form of a flexible single-layer fabric flap which, in the inflated condition of the front airbag 10, at the airbag edges spans a sail-type plane extending substantially normal to the transverse vehicle direction 36.

As an alternative, it is also imaginable, however, that the support elements 50 are double-layered and are in flow communication with the inflatable airbag volume. The support elements 50 in this case then form a respective inflatable sidewall portion of the front airbag 10 projecting from the frontal impact surface 20.

Each support element 50 in the present exemplary arrangement is a separate airbag component and is tightly connected, and in one exemplary arrangement, sewn, to the airbag panel 18. Especially in configuration variants including inflatable support elements 50, it is alternatively also imaginable, however, that the support element 50 is integrated in the airbag cut and thus formed integrally with the airbag panel 18.

In view of an airbag geometry in a longitudinal section in parallel to the longitudinal vehicle axis A, the front airbag 10 comprises an inflatable first airbag leg 22 for resting against a first vehicle component, especially the windshield 26, which first airbag leg in the mounted and inflated condition of the front airbag 10 extends from the airbag mouth 16 toward a second vehicle component, especially the instrument panel 24, and comprises an inflatable second airbag leg 28 for resting against the second vehicle component which extends from an end of the first airbag leg 22 opposed to the airbag mouth 16 in the direction of the vehicle occupant 40 to a free leg end 32 and includes the frontal impact surface 20 for the vehicle occupant 40 to be protected.

According to FIG. 2, the first airbag leg 22 encloses with the second airbag leg 28 an angle α with α<180°. In one exemplary arrangement, the angle α is α<120°, and defines a clearance 34 facing the vehicle occupant 40 to be protected and being especially wedge-shaped.

The clearance 34 defined by the two airbag legs 22, 28 is confined by a respective support element 50 at each of the two lateral airbag edges opposed in the transverse vehicle direction 36, wherein each support element 50 is tightly connected, especially sewn, both to the first airbag leg 22 and to the second airbag leg 28.

FIG. 3 illustrates a vehicle cutout according to FIG. 2 comprising an afore-described inflated front airbag 10 in the event of impact of the vehicle occupant 44.

It becomes apparent that, when an occupant impacts, the one of the two lateral support elements 50 extends on the left side of the vehicle occupant 40 and the other one of the two lateral support elements 50 extends on the right side of the vehicle occupant 40 between the two airbag legs 22, 28.

In particular, in the event of diagonal crash of the vehicle 14, a transverse acceleration component which may entail rotation of the occupant's head 52 about the longitudinal body axis B and/or sliding of the occupant's head 52 off the frontal impact surface 20 in the transverse vehicle direction 36 will act on the vehicle occupant 40, especially on the occupant's head 52. Accordingly, the lateral support elements 50 contact the head 52 of the vehicle occupant 40, however, and prevent the occupant's head 52 from excessively rotating and from excessively laterally sliding off. Said stabilization of the head 52 helps to reduce the physical load during occupant restraint and, on the whole, to improve the restraining comfort for the vehicle occupant 40.

1. A front airbag for mounting on a vehicle roof, comprising:
an airbag mouth for filling an inflatable airbag volume with generator gas, wherein the airbag mouth in a mounted condition of the front airbag is facing the vehicle roof, and
an airbag panel defining the shape of the inflatable airbag volume and, in the mounted and inflated condition of the front airbag, including a frontal impact surface for a vehicle occupant to be protected,
wherein at a lateral edge of the frontal impact surface a support element protruding from the frontal impact surface toward the vehicle roof is provided for contacting and laterally stabilizing an occupant's head.

2. The front airbag according to claim 1, wherein the lateral support element is a flexible flat support element.

3. The front airbag according to claim 1, wherein the lateral support element is double-layered and is in flow communication with the inflatable airbag volume.

4. The front airbag according to claim 1, wherein the support element is tightly connected to the airbag panel.

5. The front airbag according to claim 1, wherein at each of two opposite lateral edges of the frontal impact surface, a support element protruding from the frontal impact surface toward the vehicle roof is provided for contacting and laterally stabilizing the occupant's head.

6. The front airbag according to claim 1, wherein an inflatable first airbag leg for resting against a first vehicle component, wherein the first airbag leg in the mounted and inflated condition of the front airbag extends from the airbag mouth in a direction of a second vehicle component, as well as
an inflatable second airbag leg for resting against the second vehicle component which second airbag leg extends from an end of the first airbag leg opposed to the airbag mouth to a free leg end and includes the frontal impact surface for the vehicle occupant to be protected,
wherein the first airbag leg encloses with the second airbag leg an angle with α<180° and defines a clearance facing the vehicle occupant to be protected, and
wherein said clearance is confined by the support element at a lateral airbag edge.

7. The front airbag according to claim 6, wherein the clearance defined by the two airbag legs and facing the vehicle occupant to be protected is confined by a respective support element at each of the two opposed lateral airbag edges.

8. The front airbag according to claim 6 wherein the support element is tightly connected both to the first airbag leg and to the second airbag leg.

9. A front airbag module for mounting on a vehicle roof, comprising
a front airbag comprising an airbag mouth for filling an inflatable airbag volume with generator gas, wherein the airbag mouth in a mounted condition of the front airbag is facing the vehicle roof, and an airbag panel defining the shape of the inflatable airbag volume and, in the mounted and inflated condition of the front airbag, including a frontal impact surface for a vehicle occupant to be protected, wherein at a lateral edge of the frontal impact surface, a support element protruding from the frontal impact surface toward the vehicle roof is provided for contacting and laterally stabilizing an occupant's head, and
a gas generator mountable to the vehicle roof for filling the front airbag with generator gas through the airbag mouth thereof.

10. A vehicle comprising
a windshield which extends in a transverse vehicle direction,
a vehicle roof which includes a roof cross member adjacent to an upper edge of the windshield,
an instrument panel which, adjacent to a lower edge of the windshield, extends away from the windshield toward a vehicle interior, and
a front airbag module mounted on the vehicle roof wherein the front airbag module further includes a front airbag comprising an airbag mouth for filling an inflatable airbag volume with generator gas, wherein the airbag mouth in a mounted condition of the front airbag is facing the vehicle roof, and an airbag panel defining the shape of the inflatable airbag volume and, in the mounted and inflated condition of the front airbag, including a frontal impact surface for a vehicle occupant to be protected, wherein at a lateral edge of the frontal impact surface, a support element protruding from the frontal impact surface toward the vehicle roof is provided for contacting and laterally stabilizing an occupant's head,
wherein the support element has a flat design and spans a plane extending substantially normal to a transverse vehicle direction.

11. The front airbag according to claim 2, wherein the lateral support element is one of a fabric flap or a foil.

12. The front airbag according to claim 2, wherein the lateral support element is double-layered and is in flow communication with the inflatable airbag volume.

13. The front airbag according to claim 11, wherein the support element is tightly connected to the airbag panel.

14. The front airbag according to claim 13, wherein at each of two opposite lateral edges of the frontal impact surface, a support element protruding from the frontal impact surface toward the vehicle roof is provided for contacting and laterally stabilizing the occupant's head.

15. The front airbag according to claim 6, wherein the first vehicle component is a windshield and wherein the second vehicle component is an instrument panel.

16. The front airbag module according to claim 9, further comprising an inflatable first airbag leg for resting against a first vehicle component, wherein the first airbag leg in the mounted and inflated condition of the front airbag extends from the airbag mouth in a direction of a second vehicle component, as well as
an inflatable second airbag leg for resting against the second vehicle component which second airbag leg extends from an end of the first airbag leg opposed to the airbag mouth to a free leg end and includes the frontal impact surface for the vehicle occupant to be protected,
wherein the first airbag leg encloses with the second airbag leg an angle with α<180° and defines a clearance facing the vehicle occupant to be protected, and
wherein said clearance is confined by the support element at a lateral airbag edge.

17. The front airbag module according to claim 16, wherein the first vehicle component is a windshield and wherein the second vehicle component is an instrument panel.
